(19) United States
(12) Patent Application Publication
(10) Pub. No.: US 2016/0107149 A1
(43) Pub. Date: Apr. 21, 2016

(54) COMPOSITION FOR ENHANCED LIFE TIME OF CHARGE CARRIERS FOR SOLAR HYDROGEN PRODUCTION FROM WATER SPLITTING

(71) Applicant: COUNCIL OF SCIENTIFIC & INDUSTRIAL RESEARCH, New Delhi (IN)

(72) Inventors: Chinnakonda Subramanian Gopinath, Pune, Maharashtra (IN); Kumarsrinivasan Sivaranjani, Pune, Maharashtra (IN)

(73) Assignee: Council of Scientific & Industrial Research, New Delhi (IN)

(21) Appl. No.: 14/889,781

(22) PCT Filed: May 8, 2014
(86) PCT No.: PCT/IN2014/000311

§ 371 Date: Nov. 6, 2015

(30) Foreign Application Priority Data
May 9, 2013 (IN) 1383/DEL/2013

(51) Int. Cl. B01J 27/24; B01J 37/08; B01J 37/34; B01J 35/00; B01J 35/10

(52) U.S. Cl. CPC B01J 27/24; B01J 35/004; B01J 35/1019; B01J 37/341; B01J 37/08

(57) ABSTRACT

Disclosed herein are nanocomposite compositions comprising nano metal cluster containing titania and anion doped titania prepared by a simple one step for enhanced life time of charge carriers.

### FIELD OF THE INVENTION

The present invention provides a nanocomposite composition for enhanced life time of charge carriers for solar hydrogen production from water splitting.

Particularly the present invention discloses a nanocomposite composition comprising nanometal cluster containing titania and anion doped titania prepared by a simple one step process.

### BACKGROUND AND PRIOR ART OF THE INVENTION

Visible light driven photocatalytic water splitting reaction (WSR) is projected to be an indispensable solution to meet a significant part of clean and sustainable energy demand at global level. Producing hydrogen, a clean fuel, from water, catalyst and sun light, by overall water splitting reaction is an ultimate goal to sustain the globe in a better way. In spite of many efforts in the past, overall water splitting reaction (OWSR) by visible light driven photocatalysis is yet to produce a breakthrough in terms of quantum efficiency (QE) close to 10% or above, which is the bench mark to think about commercialization. There are significant number of reports available on WSR and OWSR, and much more concerted efforts are necessary to produce a sustainable photocatalyst system. Along with visible light absorption, charge carrier recombination probability should be suppressed or minimized to increase the QE.

TiO₂ is considered to be the best candidate for photocatalysis, however, large band gap and fast charge carrier recombination are considered to be the major drawbacks of TiO₂. It has been demonstrated that nitride or anionic nitrogen is responsible for band gap reduction and visible light absorption in TiO₂₋ₓNₓ. Several processes have been reported for preparation of TiO₂₋ₓNₓ. However, most processes are highly time and energy consuming as well as expensive, making them unattractive for large scale commercialization.

Nano noble metal cluster deposition on titania acts as an electron sink, but the final properties of such composites mainly depends on the preparation procedure. Barnwenda et al in (J. Photochem. Photobiol., A 1995, 89, 177-189) prepared Au/TiO₂ and Pt/TiO₂ photocatalysts by different preparation routes and showed its photocatalytic activity towards H₂ generation from aqueous ethanol solution.

Recently Murdoch et al have shown the WSR activity of 1.1×10⁻⁶ mol/m². min with aqueous ethanol under 350 nm (UV) light source. This activity is independent of the gold cluster size between 3 and 30 nm and the maximum activity is observed with the anatase phase. (M. Murdoch, G. I. N. Waterhouse, M. A. Nadeem, J. B. Metson, M. A. Keane, R. F. Howe, J. Llorca, H. Idriss. H. Nat. Chem. 2011, 3, 489-492). Electron injection from Au to the conduction band (CB) of titania was suggested due to strong localization of plasmonic near fields close to the Au—TiO₂ interface, but with laser sources (Z. Liu, W. Hou, P. Pavaskar, M Aykol, S. B. Cronin, Nano Lett. 2011, 11, 1111-1116; Adleman, J. R., Boyd, D. A., Goodwin, D. G. & Psaltis, D. Nano Lett. 9, 4417-4423 (2009)). However, H₂ production through WSR or photocurrent generation with Au—TiO₂ composite (above references) demonstrates its high potential and that a better understanding would lead to increase in activity.

Recent review on noble metal clusters on oxide semiconductors for solar water splitting insists on new synthetic methodologies for higher photocatalytic activity for WSR (S. Linic, P. Christopher, D. B. Ingram, Nat. Mater. 2011, 10, 911-921). To the best of our knowledge, none of the above references or references available in the literature mention about the life time measurements on noble metal clusters on oxide semiconductors and relate to photocatalytic activity under visible light irradiation conditions.

The prior art procedures lead to bigger noble metal particles deposition on N doped titania, leading to poor efficiencies. Further, prior arts disclose only noble metal clusters on titania, but there is no prior art available with noble metal on N-doped titania.

Generally, synthesis of noble metal on oxide semiconductor involves the synthesis of metal nanoparticles separately by well-known methods, such as citrate reduction or borohydride reduction of noble metal ions to noble metal nanoclusters. The above prepared nanometal clusters are capped with surfactants (such as, dodecanethiol, mercaptopropionic acid, tetraoctylammonium bromide) to prevent agglomeration and at a later stage deposited on (separately prepared) oxide support (V. Subramanian, E. E. Wolf, P. V. Kamat, J. Am. Chem. Soc. 2004, 126, 4943-4950). Alternately, noble metal can be evaporated directly and deposited as metal clusters on thin films of oxide supports under high vacuum conditions. Further, preparation of mesoporous titania involves employing a surfactant and the same to burnt later under high temperatures. Gold catalysts were prepared by a deposition-precipitation method over TiO₂ particles prepared by the sol gel process (M. Murdoch, G. I. N. Waterhouse, M. A. Nadeem, J. B. Metson, M. A. Keane, R. F. Howe, J. Llorca, H. Idriss. H. Nat. Chem. 2011, 3, 489-492). Titania has been prepared by electrochemical oxidation of titanium foil and then gold was deposited by evaporation method (Z. Liu, W. Hou, P. Pavaskar, M. Aykol, S. B. Cronin, Nano Lett. 2011, 11, 1111-1116). Very recently, WSR activity with aqueous isopropanol under visible light illumination (λ=450-600 nm) with H₂ yield of 17.4-54 and 130 μmol/g·h for Au/TiO₂ and Au+Pt/TiO₂, respectively, was reported (A. Tanaka, S. Sakaguchi, K. Hashimoto, H. Kominami, ACS Catal. 2013, 3, 79-85; ibid, Catal. Sci. Technol. 2012, 2, 907-909).

Above methods involve laborious chemical processes or evaporation involves the usage of expensive vacuum deposition techniques, such as pulsed laser deposition, chemical vapor deposition etc. Above methods does not ensure the electronic integration of semiconductor oxide and noble metal nanoparticles. Success of the photocatalyst design for WSR depends on the lifetime of charge carriers for electron injection to occur from metal nanoparticles into the conduction band of oxide semiconductor. The present invention successfully overcomes the problems in the prior art by providing a novel nanocomposite composition that enhances the life time of charge carriers for solar hydrogen production from water splitting.

### Objects of the Invention

The main objective of the present invention is to provide a nanocomposite composition that enhances the life time of charge carriers for solar hydrogen production from water splitting.

Another objective of the invention is to provide the simplest process for synthesis of composition that enhances life time of charge carriers.

Yet another objective of the present invention is to provide a nanocomposite composition that result in higher H₂ generation, preferably in sunlight.

### SUMMARY OF THE INVENTION

Accordingly, present invention provides a nanocomposite composition comprising 90 to 99.99% A along with, 0.01 to 10% B, 1 to 10% C and 1 to 5% D either alone or combination thereof, wherein A is an oxide of transition metal selected from the group consisting of Ti, Zn, Co, Fe, Mn; B is a noble metal selected from the group consisting of Au, Ag, Pt, Pd, Ir either alone or combinations thereof, C is an anion selected from N, S either alone or combinations thereof and D is selected from the group consisting of reduced graphene oxide (RGO), graphene oxide (GO) or carbon nanotubes.

In one embodiment of the present invention, carbon nanotubes are selected from the group consisting of single walled, double walled and multi walled nano tubes.

In another embodiment of the present invention, said composition is useful for enhanced life time of charge carriers for solar hydrogen production from water splitting having greater than 2 pico seconds (ps) lifetime.

In another embodiment, present invention provides a one step process for the preparation of a nanocomposite composition comprising A, B and C wherein the said process comprises:
i. heating an aqueous solution of transition metals (A) salts selected from the group consisting of titanyl nitrate, Zinc nitrate, Cobalt nitrate, Ferrric nitrate, Manganese nitrate; a source of an anion (C) selected from the group consisting of amino acids, hydrazine, urea and thiourea and an aqueous solution of noble metal (B) salts selected from the group consisting of gold chloride, palladium chloride, platinum ammonium chloride, iridium chloride and silver chloride in the ratio ranging between 90:0.01:1 to 99.99:10:10 at a high temperature in the range of 100 to 500° C. for period between 10 min. And 120 min to obtain the nanocomposite composition.

In another embodiment, present invention provides a process for the preparation of a nanocomposite composition comprising A along with B and D either alone or combination thereof wherein said process comprising the steps of:
a) dispersing 90 to 99.99% transition metal oxide in water-ethanol solution;
b) adding 1 to 5% source of carbon to solution of step (a) followed by sonication till uniform dispersion is obtained;
c) optionally adding 0.01 to 10% aqueous solution of salts of noble metals to dispersion of step (b) and
d) heating the contents of step (b) or (c) upto 180° C. for 5 to 6 hours to obtain composition.

In another embodiment of the present invention, the nanocomposite composition is preferably Au—TiO₂:N, Ag—TiO₂:N, Pt—TiO₂:N, Pd—TiO₂:N, and Ir—TiO₂:N.

In yet another embodiment of the present invention, Au—TiO₂:N is characterized by pore diameter in the range of 6 to 10 nm and by surface area in the range of 150-250 m²g⁻¹.

In yet another embodiment of the present invention, Au—TiO₂:N is exhibits 640 to 1510 μmol/g·h solar hydrogen generation under visible light irradiation.

### BRIEF DESCRIPTION OF FIGURES

FIG. 1(a) depicts a wide angle powder XRD pattern, of xAu-NT nanocomposites. The inset in 1(a) shows the low angle XRD pattern of all xAu-NT materials.

No feature is observed at 0.10Au-NT in the XRD patterns that corresponds to metallic gold. However, 0.30Au-NT shows a peak at 2θ=44° corresponding to (200) plane of metallic gold thus supporting the presence of highly dispersed nano gold clusters on xAu-NT (x>0.1). Mesoporous nature of Au-NT materials was confirmed by 2θ=1°. Only one peak was observed indicating the disordered mesoporosity.

FIG. 1b depicts the UV-visible absorption spectra of xAu-NT nanocomposites. The absorption edge of titania shows a marginal red shift due to nitrogen doping. Inset in 1(b) shows a photograph for the color variation with increasing Au-content of xAu-NT, with sample labels as A=N—TiO2, B=0.01Au-NT, C=0.03Au-NT, D=0.05AuNT, E=0.10AuNT and F=0.30Au-NT.

N—TiO₂ shows a pale yellow color, and upon Au introduction blue to grayish blue color develops gradually. On increasing Au to 0.1 atom % and above, the color changes increasingly towards dark blue. SPR (Surface plasmon resonance) features of nano Au in composite materials bring more visible light absorption between 500-750 nm.

FIG. 2 depicts the photocatalytic H₂ evolution activity of (a) 0.05Au-NT for 15 h, and (b) xAu-NT nanocomposites in visible light with aqueous methanol. Amount of H₂ evolution reported is with 100 mg of catalyst. Dotted lines in (a) indicate evacuation after every 5 h.

FIG. 3(a) depicts Raman spectra for different ratios of TiO₂—RGO (Reduced graphene oxide) nanocomposites. Formation of RGO-TiO₂ composite is evident from Raman spectra. D and G band of RGO is clearly observed at 1330 and 1595 cm⁻¹. Intensity ratio of above bands (I_{D}/I_{G}) indicates the amount of disorder (or) defects associated with RGO. I_{D}/I_{G} ratio is very low for 1 and 3 wt. % RGO-TiO₂ (1.22 & 1.23) and higher for 5 wt % RGO-TiO₂ (1.31). Only pure anatase phase features are observed in the composite materials, along with RGO features. The electrical or physical link between RGO and titania is further supported by high resolution transmission electron microscopy studies (FIG. 3b). A long mat (rod) like feature on the top portion of FIG. 3b demonstrates the connectivity between RGO and several titania island of particles.

FIG. 4 depicts the emission decay of xAu-NT (x=0.05 and 0.1), and TiO₂₋ₓNₓ. The materials excited with 375 nm LED source, were determined for emission decay at 440 nm with 5000 counts. For TiO₂₋ₓNₓ, before gold loading, its lifetime was measured to be 1.76 ps. Upon introduction of nano gold on titania (0.05Au-NT), the lifetime of titania species increases to 21.1 ps. An order of magnitude increase in the lifetime from NT (1.76 ps) to Au-NT (21.1 ps) underscores the importance of gold introduction. Above observation directly demonstrates the energy transfer from nano gold to titania in an effective manner.

### DETAILED DESCRIPTION OF THE INVENTION

The present invention discloses an electronically integrated nanocomposite composition for enhanced life time of charge carriers for solar hydrogen production from water splitting and the said composition comprising A along with B, C or D either alone or combination thereof, wherein A is selected from an oxide of a transition metal, preferably Ti, Zn, Fe, Co, Mn; B is selected from noble metals, preferably Au, Ag, Pt, Pd, Ir, or combinations thereof and C is an anion, selected from N, S or combinations thereof and D is selected from the group consisting of reduced graphene oxide (RGO), graphene oxide (GO) or carbon nanotubes. Further, the carbon nanotubes of D are selected from single walled, double walled and multi-walled nano tubes.

Further, the present invention discloses a novel, simple one step process for the preparation of composition comprising A, B and C, wherein the said process comprises heating an aqueous solution of salts of transition metals, source of anion, preferably urea and aqueous solution of salts of noble metals together at high temperatures for sufficient time to obtain the composition.

Accordingly, the transition metals (A) salts are selected from the group consisting titanyl nitrate, Zinc nitrate, Ferric nitrate, etc, Cobalt nitrate or Manganese nitrate.

The noble metal (B) salts are selected from the group consisting gold chloride, palladium chloride, platinum ammonium chloride, iridium chloride and silver chloride.

The noble metal (B) is optionally selected from the group having more than one component selected from the group consisting of Au+Ag, Au+Pt, Ag+Pt and Au+Ag+Pt.

The process is carried out at temperatures ranging from 100-500° C. for 5-20 minutes.

Further, the present invention discloses a process for synthesis of composition ABD comprising:
a. dispersing transition metal oxide in water-ethanol solution;
b. adding source of carbon to solution of step (a) and sonicating till uniform dispersion is obtained;
c. adding aqueous solution of salts of noble metals to dispersion of step (b) and
d. heating the contents of step (c) upto to 180° C. for 6 hours to obtain composition ABD.

Further, the present invention discloses a process for synthesis of composition AD comprising:
a. dispersing transition metal-oxide in water-ethanol solution;
b. adding source of carbon to solution of step (a) and sonicating till uniform dispersion is obtained;
c. heating the contents of step (b) up to 180° C. for 6 hours to obtain composition AD.

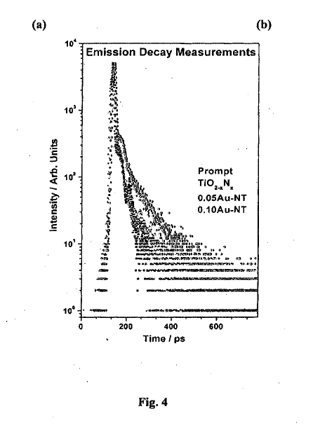

Further, the nanocomposite composition of the instant invention results in enhanced lifetime of charge carriers, particularly electrons, of greater than 2 pico seconds (ps). FIG. 4 depicts the emission decay of xAu-NT (x=0.05 and 0.1), and TiO₂₋ₓNₓ. The materials excited with 375 nm LED source, were determined for emission decay at 440 nm with 5000 counts. For TiO₂₋ₓNₓ, before gold loading, its lifetime was measured to be 1.76 ps. Upon introduction of nano gold on titania (0.05Au-NT), the lifetime of titania species increases to 21.1 ps. An order of magnitude increase in the lifetime from NT (1.76 ps) to Au-NT (21.1 ps) underscores the importance of gold introduction. Above observation directly demonstrates the energy transfer from nano gold to titania in an effective manner.

In the instant nanocomposite composition comprising A, B and C, the transition metal oxide (TiO2) is doped using the anion source thus reducing the band gap of TiO₂ and brings about the absorption of more visible light.

The source of the anion N i.e. nitrogen is selected from easily combustible compounds such as amino acids, hydrazine, urea, thiourea, preferably urea and that of anion S i.e. sulphur may be selected from thio urea.

The concentration of the noble metal (B) is in the range of 0.01-0.3%.

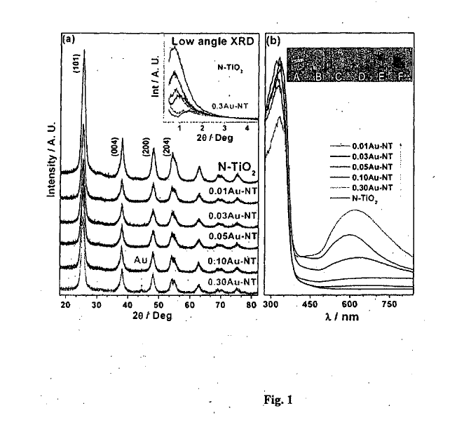

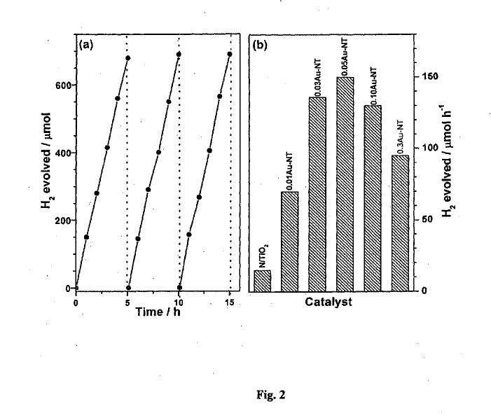

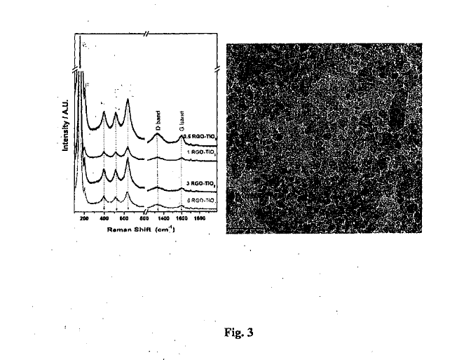

The present invention provides a nanocomposite composition comprising A, B and C, wherein Au—TiO₂:N nanocomposites possesses disordered mesoporosity, low meso-channel depth (≦10 nm) and high surface area in the range of 150-250 m²/g and electrically interconnected nanoparticles (EINP) (FIG. 1b), The surface plasmon resonance (SPR) of composition A-B-C appears in broad visible light in the range (FIG. 1b) between 500 and 800 nm for Au on TiO₂₋ₓNₓ composites. This indicates the absorption of large percent of visible light in the solar spectrum.

Further, the photocatalytic H₂-generation activity of the nanocomposite composition is in the range of 1-1.8 mmol h⁻¹ g⁻¹.

### EXAMPLES

Following examples are given by way of illustration therefore should not be construed to limit the scope of the invention.

### Synthesis of Nanocomposite of Gold on N Doped Titania

### Example 1

Aqueous titanyl nitrate (5.684 gms), 0.0008 g of gold chloride and 12 g of urea were taken in a 250 ml beaker and introduced into a muffle furnace maintained at 400° C. Solid product was obtained in ten minutes with 0.01% gold on N doped titania.

### Example 2

Aqueous titanyl nitrate (5.698 gms), 0.0024 g of gold chloride and 12 g of urea were taken in a 250 ml beaker and introduced into a muffle furnace maintained at 400° C. Solid product was obtained in ten minutes with 0.03% gold on N doped titania.

### Example 3

Aqueous titanyl nitrate (5.682 gms), 0.0040 g of gold chloride and 12 g of urea were taken in a 250 ml beaker and introduced into a muffle furnace maintained at 400° C. Solid product was obtained in ten minutes with 0.05% gold on N doped titania.

### Example 4

Aqueous titanyl nitrate (5.679 gms), 0.0080 g of gold chloride and 12 g of urea were taken in a 250 ml beaker and introduced into a muffle furnace maintained at 400° C. Solid product was obtained in ten minutes with 0.1% gold on N doped titania.

### Example 5

Aqueous titanyl nitrate (5.668 gms), 0.024 g of gold chloride and 12 g of urea were taken in a 250 ml beaker and introduced into a muffle furnace maintained at 400° C. Solid product was obtained in ten minutes with 0.3% gold on N doped titania.

### Example 6

The nanocomposite of gold on N doped titania prepared according to examples 1-5 were characterized by XRD and UV-Visible absorption spectroscopy (Refer FIGS. 1 a and 1b).

### Example 7

Aqueous titanyl nitrate (5.679 gms), 0.0035 g of Palladium chloride and 12 g of urea were taken in a 250 ml beaker and introduced into a muffle furnace maintained at 400° C. Solid product was obtained in ten minutes with 0.1% Pd on N doped titania.

### Example 8

Aqueous titanyl nitrate (5.679 gms), 0.007 g of Platinum ammonium chloride and 12 g of urea were taken in a 250 ml beaker and introduced into a muffle furnace maintained at 400° C. Solid product was obtained in ten minutes with 0.1% Pt on N doped titania.

### Example 9

Aqueous titanyl nitrate (5.679 gms), (0.006) g of Iridium chloride and 12 g of urea were taken in a 250 ml beaker and introduced into a muffle furnace maintained at 400° C. Solid product was obtained in ten minutes with 0.1% Ir on N doped titania.

### Example 10

Aqueous titanyl nitrate (5.679 gms), 0.00014 g of Silver chloride and 12 g of urea were taken in a 250 ml beaker and introduced into a muffle furnace maintained at 400° C. Solid product was obtained in ten minutes with 0.1% Ag on N doped titania.

### Example 11

For mixed Au+Pt on N-doped titania—5.679 g of titanyl nitrate+0.0008 gold chloride+0.007 g of platinum ammonium chloride+12 g of urea were taken in a 250 ml beaker and introduced into a muffle furnace maintained at 400° C. Solid product was obtained in ten minutes with 0.01% Au+0.1% Pt on N doped titania.

### Example 12

For mixed Au+Ag on N-doped titania—5.679 g of titanyl nitrate+0.0008 gold chloride+0.00014 g of silver chloride+12 g of urea were taken in a 250 ml beaker and introduced into a muffle furnace maintained at 400° C. Solid product was obtained in ten minutes with 0.01% Au+0.1% Ag on N doped titania.

### Example 13

For mixed Ag+Pt on N-doped titania—5.679 g of Titanyl nitrate+0.00014 g of silver chloride+0.007 g of platinum ammonium chloride+12 g of urea were taken in a 250 ml beaker and introduced into a muffle furnace maintained at 400° C. Solid product was obtained in ten minutes with 0.1% Ag+0.1% Pt on N doped titania.

### Example 14

For mixed Au+Pt+Ag on N-doped titania—5.679 g of titanyl nitrate+0.0008 gold chloride+0.007 g of platinum ammonium chloride+0.00014 g of silver chloride+12 g of urea were taken in a 250 ml beaker and introduced into a muffle furnace maintained at 400° C. Solid product was obtained in ten minutes with 0.01% Au+0.1% Pt+0.1% Ag on N doped titania.

### Example 15

Disperse 1 g of TiO₂ in (100 ml) water—(50 ml) ethanol solution. Add 10 mg of GO (Graphene oxide) and sonicating till uniform dispersion is obtained. Heat it to 180° C. for 6 hours in an oven to obtain composition 1 wt % RGO-TiO₂ nanocomposite.

### Example 16

Disperse 1 g of TiO₂ in (100 ml) water—(50 ml) ethanol solution. Add 30 mg of GO and sonicating till uniform dispersion is obtained. Heat it to 180° C. for 6 hours in an oven to obtain composition 3 wt % RGO-TiO2 nanocomposite.

### Example 17

Disperse 1 g of TiO₂ in (100 ml) water—(50 ml) ethanol solution. Add 50 mg of GO and sonicating till uniform dispersion is obtained. Heat it to 180° C. for 6 hours in an oven to obtain composition 5 wt % RGO-TiO₂ nanocomposite.

### Example 18

Disperse 1 g of TiO₂ in (100 ml) water—(50 ml) ethanol solution. Add 10 mg of multiwalled carbon nanotube and sonicating till uniform dispersion is obtained. Heat it to 180° C. for 6 hours in an oven to obtain composition 1 wt % CNT (Carbon nantube)-TiO₂ nanocomposite.

### Example 19

### Synthesis of Nanocomposite of Gold on Reduced Graphene Oxide-Titania (Photodeposition)

10 mg of gold chloride and 1 g of 1 wt % RGO-TiO₂ is dispersed in 100 ml methanol—50 ml water mixture. The dispersion was deareated by passing Ar gas for half an hour. Irradiate this dispersion with UV light for at least 1 h to get 1 wt % gold on 1 wt % RGO-TiO2.

### Example 20

### Photocatalytic Activity Evaluation of any of the Above Nanocomposites

The photocatalytic activity was measured for the H₂O splitting under visible light. The reaction was carried out at ambient conditions using a borosil photoreactor of ca. 50 ml capacity, equipped with a port for the withdrawal of gas samples at regular intervals. For each experiment, 100 mg of fresh nanocomposite was dispersed in 32 ml water and 8 ml methanol to serve as sacrificial reagent. 125 W simulated white light source was used as irradiation source. Newport solar simulator with 125 W light source with AM1.5 filter was also used for many experiments. The experiments were conducted at around pH=7. Hydrogen evolved was sampled and analyzed periodically on a gas chromatograph (Chemito, model-8610, Porapak-Q column, thermal conductivity detector at 353 K).

TABLE 1
Solar hydrogen generation from Au—TiO₂ under visible light irradiation

| Material | Hydrogen generated (μmol/g · h) |
|---|---|
| TiO_{1.92}N_{0.08} | 150 |
| 0.01Au—TiO_{1.92}N_{0.08} | 640 |
| 0.03Au—TiO_{1.92}N_{0.08} | 1370 |
| 0.05Au—TiO_{1.92}N_{0.08} | 1510 |
| 0.1Au—TiO_{1.92}N_{0.08} | 1290 |
| 0.3Au—TiO_{1.92}N_{0.08} | 950 |

### ADVANTAGES OF THE INVENTION

The instant composition finds application in solar cell, photo catalytic applications, H₂ generation and many others.
The instant composition serves as a solution to provide clean and sustainable energy demand.
Simple process of preparation of nano composites.
One step process.
Enhanced life time of charge carrier.
Enhanced production of H₂, preferably under sunlight.

1. A composition comprising 90 to 99.99% A along with, 0.01 to 10% B, 1 to 10% C and 1 to 5% D either alone or combination thereof, wherein A is an oxide of transition metal selected from the group consisting of Ti, Zn, Co, Fe, Mn; B is a noble metal selected from the group consisting of Au, Ag, Pt, Pd, Ir either alone or combinations thereof, C is an anion selected from N, S either alone or combinations thereof and D is selected from the group consisting of reduced graphene oxide (RGO), graphene oxide (GO) or carbon nanotubes.

2. The composition according to claim 1, wherein carbon nanotubes are selected from the group consisting of single walled, double walled and multi walled nano tubes.

3. The composition as claimed in claim 1, wherein said composition is useful for enhanced life time of charge carriers for solar hydrogen production from water splitting having greater than 2 pico seconds (ps) lifetime.

4. A one step process for the preparation of composition comprising A, B and C according to claim 1, wherein the said process comprises:
i. heating an aqueous solution of transition metals (A) salts selected from the group consisting of titanyl nitrate, Zinc nitrate, Cobalt nitrate, Ferrric nitrate, Manganese nitrate; a source of an anion (C) selected from the group consisting of amino acids, hydrazine, urea and thiourea and an aqueous solution of noble metal (B) salts selected from the group consisting of gold chloride, palladium chloride, platinum ammonium chloride, iridium chloride and silver chloride in the ratio ranging between 90:0.01:1 to 99.99:10:10 at a high temperature in the range of 100 to 500° C. for period between 10 min. And 120 min to obtain the nanocomposite composition.

5. A process for the preparation of composition comprising A along with B and D either alone or combination thereof as claimed in claim 1, wherein said process comprising the steps of:
a) dispersing 90 to 99.99% transition metal oxide in water-ethanol solution;
b) adding 1 to 5% source of carbon to solution of step (a) followed by sonication till uniform dispersion is obtained;
c) optionally adding 0.01 to 10% aqueous solution of salts of noble metals to dispersion of step (b) and
d) heating the contents of step (b) or (c) upto 180° C. for 5 to 6 hours to obtain composition.

6. The composition as claimed in claim 1, wherein the nanocomposite composition is preferably Au—TiO₂:N, Ag—TiO₂:N, Pt—TiO₂:N, Pd—TiO₂:N, and Ir—TiO₂:N.

7. The composition as claimed in claim 6, wherein Au—TiO₂:N is characterized by pore diameter in the range of 6 to 10 nm and by surface area in the range of 150-250 m² g⁻¹.

8. The composition as claimed in claim 7, wherein Au—TiO₂:N is exhibit 640 to 1510 μmol/g·h Solar hydrogen generation under visible light irradiation.
